(19) United States
(12) Patent Application Publication
(10) Pub. No.: US 2018/0297188 A1
(43) Pub. Date: Oct. 18, 2018

(54) MULTI-USE HATCHET

(71) Applicants: Scott McCann, Spokane, WA (US); Karen McCann, Spokane, WA (US)

(72) Inventors: Scott McCann, Spokane, WA (US); Karen McCann, Spokane, WA (US)

(21) Appl. No.: 15/488,150

(22) Filed: Apr. 14, 2017

(51) Int. Cl. B25F 1/00; B26B 23/00; B25G 1/10; A62B 3/00

(52) U.S. Cl. CPC B25F 1/006; A62B 3/005; B25G 1/102; B26B 23/00

(57) ABSTRACT

Techniques for providing a multi-use hatchet are described herein. In some examples, the multi-use hatchet may comprise a head and a handle, each comprising multiple uses or functionalities. In some examples, the head may include an anchor point and an attachment point or hole to allow a user to bail out of a hazardous environment. In various examples, the handle may comprise one or more holes to serve as a belaying device, and a sharpened distal end for plying or other functions.

### BACKGROUND

Striking implements, such as axes and hatchets, generally have a handle connected to a head with a sharpened edge. Traditional axes and hatchets primarily have a single purpose, to chop through materials such as wood. Many professions, such as firefighting, use axes and hatchets for various activities such as forcible entry, digging firelines, breaking through walls or windows, and at times, to provide support to a firefighter operating on an unstable or dangerous surface. Thus, firefighters may be required to carry axes and/or hatches while working in the chance they need to perform one of the above activities. While these traditional axes and hatchets are handy to have for a few activities, they are generally large, cumbersome, and inconvenient to carry considering the primary singular use provided by the axes and hatchets of breaking through material. Additionally, firefighters may further require additional equipment for performing other activities while working, which increases the amount of equipment and weight that a firefighter must carry.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a perspective view of an example multi-use hatchet.

FIG. 2A is a side view of a handle of an example multi-use hatchet of FIG. 1.

FIG. 2B is a cross-sectional view of the handle of the example multi-use hatchet of FIG. 1 taken along line B-B.

FIG. 3A is a side view of a head of the multi-use hatchet of FIG. 1.

FIG. 3B is a top view of a head of the example multi-use hatchet of FIG. 1.

FIG. 4 is a perspective view of another embodiment of an example multi-use hatchet.

FIG. 5A is a side view of a handle of the example multi-use hatchet of FIG. 4.

FIG. 5B is a cross-sectional view of a handle of the example multi-use hatchet of FIG. 4 taken along line B-B.

FIG. 6A is a side view of a head of the example multi-use hatchet of FIG. 4

FIG. 6B is a top view of a head of the example multi-use hatchet of FIG. 4.

FIG. 7 is a side view of another example of a multi-use hatchet having a carabiner-type opening mechanism disposed in the handle.

FIG. 8 is an example use case scenario of an example multi-use hatchet.

FIG. 9 is another example use scenario of an example multi-use hatchet.

FIG. 10 is a side-view of an example multi-use hatchet.

FIG. 11 is a side-view of another example multi-use hatchet.

FIG. 12 is a side-view of another example multi-use hatchet.

### DETAILED DESCRIPTION

This disclosure is generally directed to a striking implement, such as a hatchet or ax. In some examples, the multi-use hatchet may provide functionality for performing various actives in additional to those mentioned above.

In the firefighting industry, firefighters often are required to carry large amounts of equipment while working. For example, if a firefighter is called to help extinguish a fire in a building, the firefighter may be required to carry demolition equipment for demolishing doors, windows, and walls (e.g., an axe, a hatchet, etc.), plying equipment for plying open doors and windows (e.g., plying tools such as hammers, pick, crowbar, etc.), climbing equipment for ascending or descending from a building (e.g. an anchoring device, climbing rope, a belay device, carabiners, etc.). However, often times firefighters must climb large amounts of stairs or navigate in tight spaces. The large amount of equipment required by the firefighters may cause firefighters to become fatigued more easily and/or potentially get stuck in dangerous situations. Accordingly, it may be advantageous for firefighters to carry less equipment when working, while still having the necessary equipment readily available.

This disclosure is generally directed to a multi-use striking implement which provides various functionalities. In some examples, the striking implement may comprise a hatchet having a head and a handle. The head may include a sharpened blade for chopping or a blunt blade for demoing, a plying portion (e.g., claw or pick), a hole for receiving various types of equipment (e.g., a carabiner, a rope, etc.), and an anchor notch to anchor the hatchet to a given material (e.g., ledge of a window sill, edge of a roof top, etc.).

In various examples, the handle may include one or more holes through the handle which are sized to receive various types of equipment or objects, such as rope. In some examples, the one or more holes in the handle may be positioned such that the handle of the hatchet may be used as a belaying device or mechanism. For instance, rope may be fed through the one or more holes in various configurations to allow the hatchet to serve as a belaying device to control a rope during belaying of a climber. Based on the configuration of the one or more holes, safety for the belaying of a climber may be improved by reducing the physical effort required to manage the weight of the climber. In some examples, the one or more holes may have their edges rounded off to reduce friction caused by the movement of the rope through the holes. In various examples, the handle may further have a distal end which comes to a point that may be used for various functions, such as plying open doors and windows, or serving as an anchor notch.

While the techniques described herein are with reference to a hatchet, the techniques may similarly be applied to any type of implement comprising a handle sized to have holes placed in the handle. For example, the types of implements may include, but are not limited to, an axe, a hatchet, a hammer, a pick, a sledge hammer, a maul, a mallet, a pry bar, a crow bar, or any other type of implement comprising a handle.

The apparatuses and techniques described herein may be implemented in a number of ways. Example implementations are provided below with reference to the following figures.

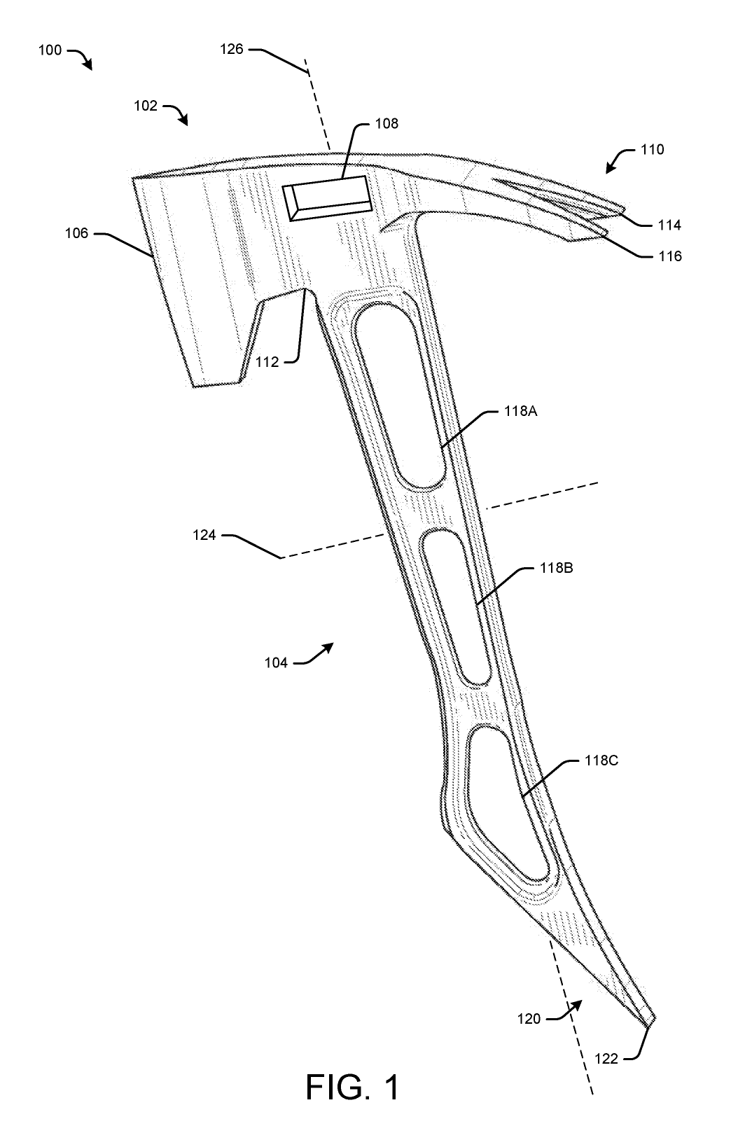

FIG. 1 is a perspective view of an example multi-use hatchet. The multi-use hatchet 100 may include a head 102 and a handle 104.

In some embodiments, the head 102 may include various components, such as a blade 106 on a front of the head 102, a hole 108 going through the width of the head 102, a plying mechanism 110, and an anchor notch 112. In some examples, the blade 106 may comprise a sharpened blade running the length of a front of the head 102 of the hatchet 100. In such examples, the blade 106 may be used for chopping through materials. In other examples, the blade 106 may comprise a blunt surface centered between beveled edges. In examples where the blade 106 comprises the blunt surface centered between beveled edges, the hatchet may be used to demo rather than chopping, and the blunt blade 106 may not get stuck in materials without a sharpened edge.

In some examples, the hole 108 that extends through the width of the head 102 may be designed to receive other objects, such as a carabiner or rope to clip or tie through the hole 108 to connect the hatchet 100 to another object hooked to the carabiner or rope. In some examples, the hole 108 may be designed to receive the another tool, such as, for example, a Halligan style pry tool, thereby allowing the two tools to be easily carried together.

In various examples, the plying mechanism 110 may comprise a pick (not shown), and in other examples, the plying mechanism may comprise a claw having a first prong and a second prong 116. In this way, the two prongs 114 and 116 join to allow the claw to pry objects (e.g., nails, screws, etc.) which fit into the “T” of the claw to enable the plying mechanism 110 to pry out the object. In some examples, the plying mechanism 110 may further serve as an anchor notch, a striking surface, or for any other useful purpose. For example, the plying mechanism may comprise a pick which may be used as a striking tool to gain access to a particular room or building. For another example, the pick may be used as an anchor notch. In such an example, a user (e.g., a firefighter) on a roof may embed the pick into the roof. Once embedded, the firefighter may stand on the top of the head, using the hatchet 100 as a step.

In some examples, the anchor notch 112 may be positioned between the handle 104 and the blade 106 on the head 102 of the hatchet 100. In such examples, the anchor notch 112 may be considered to be on the beard side of the axe face. The anchor notch 112 may be used as an anchor point, by securing the anchor notch 112 in a given material so it will not release or slip when weight is applied to the handle 104. In such embodiments, the angle on the beard side of the anchor notch 112 may be designed to pull the tool tight against the anchoring surface in order to create a stable and secure anchor point. For example, the anchor notch 112 may be secured on the ledge of a window sill, with the handle 104 oriented out the window. Once secured, a user may hook into a belay loop (e.g., holes on the handle 104), and rappel out the window to safety.

Additionally or alternatively, the beard side of the anchor notch 112 may be used as an additional striking and/or breaching surface. For example, the sharp point combined with the angle of the anchor notch 112 may be helpful in removing and breaching drywall or any other material. Once the anchor notch 112 has breached the surface of a given material, the angle of the anchor notch 112 may provide an efficient way to pull and remove the given material.

In some examples, the hatchet 100 may include the handle 1104, and the handle may comprise one or more holes 118 (e.g., 118A, 118B, 118C, etc.). While illustrated as comprising three holes, the holes 118 may comprise one hole, or any number of holes (e.g., 1, 2, 3, 4, or more holes) positioned in the handle 104 of the hatchet 100. The holes 118 may extend through the width of the handle 104. In some examples, the holes 118 may have inner circumferences which comprise hard edges (e.g., substantially 90 degrees), and in other examples, the holes 118 may have a substantially rounded or smoothed inner circumferences. For instance, the inner circumference of the holes 118 may comprise a smoothed surface with a radius, such as a half-circle, which may reduce friction caused by the rubbing of rope on the inner circumference of the holes 118 compared to the hard edge example.

In some examples, the holes 118 may be placed at various locations along the handle 104. For instance, all of the holes may be placed at a proximal end of the handle 104 near the head 102, a distal end of the handle 104, or in the middle of the handle. In other instances, the holes 118 may be placed along the entirety of the handle 104. In the example shown, a first hole 118A may be placed in a proximal portion of the handle, a second hole 118B may be placed in substantially a middle portion of the handle 104, and the bottom hole 118C may be placed in a distal portion of the handle 104. In some instances, the first hole 118A may be placed in a top third of the handle 104, the second hole 118B may be placed in a middle third of the handle 104, and the third hole 118C may be placed in a bottom third of the handle 104. The holes 118 may be sized in any configuration or shape capable of receiving a rope.

In various examples, the handle 104 may further comprise a distal portion 120 where the front of the handle 104 and the back of the handle 104 come to a point 122. In various examples, the point 122 of the distal portion 120 of the handle 104 may be used for activities such as plying open doors and windows, and/or for demoing through material.

In some examples, the hatchet 100 may be defined by a horizontal axis 124 and a vertical axis 126. As illustrated, the handle 104 of the hatchet may be elongated in a direction parallel to the vertical axis 126. The head 102 may generally extend from the blade 106 along the horizontal axis 124 to the plying mechanism 110.

In various embodiments, the components of the multi-use hatchet 100 described may be manufactured via traditional manufacturing techniques. In some embodiments, the components may be manufactured by 3-D manufacturing techniques, casting, molding, forming, machining, composite manufacturing, or any other method of manufacturing. In some embodiments, the metal may be hardened during the manufacturing process. In various embodiments, the hatchet 100 may comprise a metal material (e.g., aluminum, steel, stainless steel, titanium, iron, alloys thereof, etc.), plastic material (e.g., high-density polyethylene, acrylic, melamine, polycarbonate, etc.), a composite material (e.g., fiberglass, carbon fiber, etc.), or combinations of the foregoing. In some embodiments, the hatchet 100 may be cast, formed or machined as a solid piece. In some embodiments, the head 102 may comprise one or more pieces joined together, and the handle 104 may comprise one or more pieces joined together, which are in turned joined together with the head 102.

In some examples, the hatchet 100 may comprise different materials, have different surface finishes, textures, and/or treatments. For example, a portion of the handle near the distal end where a user would hold the hatchet 100 may be treated. In some examples, a grip may be placed on the bottom portion of the handle to facilitate better grip of the hatchet 100. In some instances, one or more portions of the surface of the hatchet 100 may be treated. For instance, the handle may have areas etched using etching equipment and/or chemical milling/industrial etching. In some examples, any portion of the surface of the handle 100 may be treated, such as by using a coating (e.g., powder coating, ceramic glaze, etc.), blanching, plating, or any other type of known surface treatment. In some examples, the surface of the holes may be treated. For example, the surface of the holes may be polished to reduce friction, or textured to increase friction. In some examples, a portion of the holes may be polished, while another portion of the holes may be textured to increase friction. The texture may include a traction feature (non-slip surface) (e.g., surface texture (e.g., knurling, indentations, raised features, or combinations thereof), rubber, plastic, etc., or combinations thereof) to prevent a rope from sliding through the holes when placed against the traction feature.

In various examples, the entire length of the hatchet 100 and the head 102 may comprise various dimensions. In some instances, the dimensions of the entire length of the hatchet 100 may be about 16 to 18 inches or less (e.g., 16.8 inches), and the length of the head 102 from the blade 106 to the back of the plying mechanism 110 may be about 8-10 inches (e.g., 8.6 inches), or less.

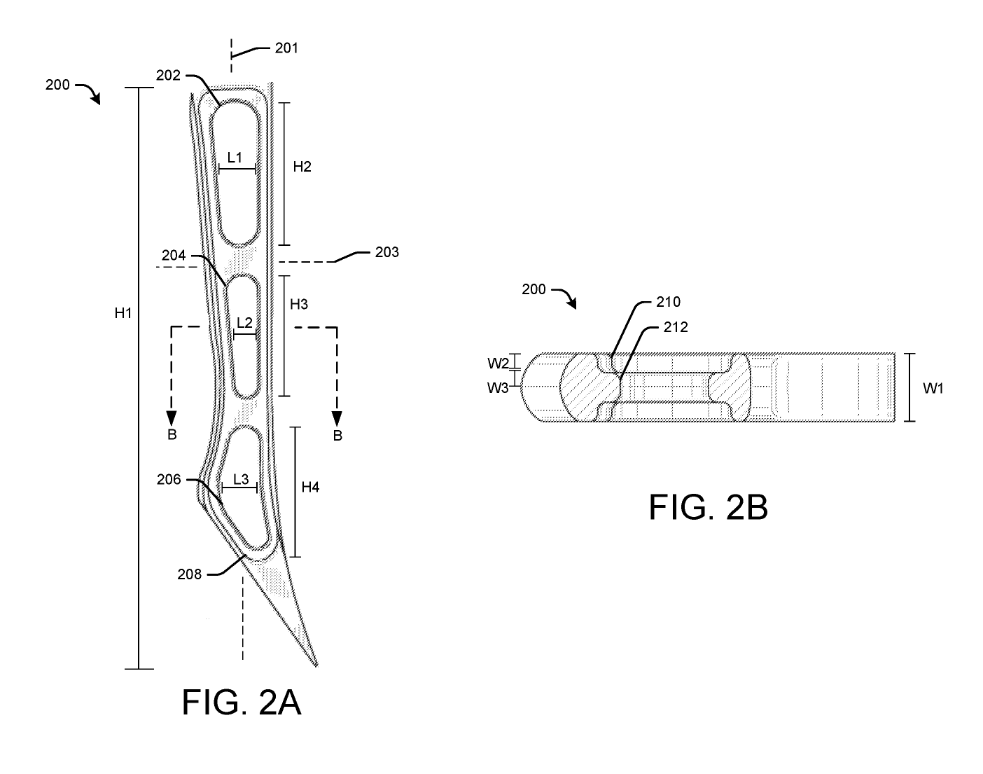

FIG. 2A is a side view of a handle 200 of an example multi-use hatchet. In some examples, the handle 200 may correspond to the handle 104 of hatchet 100.

As shown in FIG. 2A, the handle 200 may have a height H1. While the height H1 may be any height, in some examples, the height H1 may be about 13 inches to 15 inches (e.g., 14.5 inches). While the handle 200 may include one, or any number of holes, in various examples, the handle 200 may include three holes, such as hole 202, hole 204, and hole 206. In some examples, the handle 200 may be height that is elongated along a vertical axis 201, and a length that is elongated along a horizontal axis 203. As describes herein, the heights are defined along the vertical axis 201, and the lengths are defined along the horizontal axis 203. In various examples, hole 202 may be disposed in a top region of the handle 200 proximal to a head (not shown) of a hatchet or other striking implement the handle 200 may be attached to. In some instances, all or a majority of the hole 202 may be disposed in a top third of the handle 200. In some examples, a middle hole 204 may be disposed in a middle region of the handle 200. In some instances, all or the majority of hole 204 may be disposed in a middle third of the handle 200. In some instances, all or a portion of the bottom hole 206 may be disposed in a bottom third of the handle 200.

In various examples, the holes 202, 204, and 206 may generally comprise any dimension sized to receive an object, such as a rope. While the holes 202, 204, and 206 may be sized to receive any rope of any diameter, in some examples, it may be sized to receive a rope strong enough to support the weight of a human. For example, climbing ropes may have a diameter of about 9 mm to 10.7 mm (about 0.3 inches to 0.4 inches), and a circumference of about 28.26 mm to 33.6 mm (about 1.1 inches to 1.3 inches). In some examples, the holes may be sized to be about twice the dimensions of a climbing rope (e.g., 0.7 inches to 0.8 inches) to allow for a rope to be looped through the holes 202, 204, and 206 twice. As used herein, the term “about” may indicate that the value may be within a ±15% tolerance or range of the value being described. In some examples, the holes are not completely circular. In such examples, the diameters may correspond to a dimension of the hole despite not being completely circular. For instance, the “diameter” may comprise a smallest dimension, or a largest dimension, or any other dimension of a hole.

In various examples, the holes 202, 204, and 206 may comprise various other dimensions. For example, hole 202 may have a height H2 of about 3 inches to 4 inches (e.g., 3.56 inches) and a length L1 of about 1.0 inch to 2.0 inches. Hole 204 may have a height H3 of about 3.0 inches and a length L2 of about half an inch to 1 inch (e.g., 0.7 inches). Finally, hole 206 may have a height H4 of about 2.0 inches to 3.0 inches (e.g., 2.9 inches) and a length L3 of about 1.0 inch.

In various examples, the holes may have corners rounded to radii between about 1/16 of an inch and about ⅜ of an inch. In some examples the holes may have same corner rounding throughout, or different rounding. Different rounding may provide different friction between the implement and the rope. In some examples, the rounding portions for the holes, and the non-rounded portions of the holes, may be at any location on the holes.

As described above for handle 104, the holes 202, 204, and 206 in handle 200 may have an interior circumference that is rounded and smoothed, as opposed to sharp edges, to reduce friction caused from ropes or other objects being looped through the holes and moved across the interior circumferences of the holes 202, 204, and 206.

In some examples, the handle 200 may include a cutout portion 208 which surrounds the holes 202, 204, and 206. Generally, the cutout portion 208 may comprise an area which has had material “cutout” (or not poured when constructing the hatchet) relative to the width of the handle. Stated otherwise, the width of the handle may be wider than the cutout portion 208. As shown in FIG. 2A, the cutout portion 208 comprises an area that surrounds all of the holes 208. In some instances, the cutout portion 208 may reduce the weight of the handle 200 for a striking implement. The cutout portion 208 may comprise a substantially 90 degree slope from the exterior of the width of the handle 200 until the bottom of the cutout portion 208 where the holes are formed. However, the top and bottom of the cutout portion 208 may be rounded with a radius to smooth out the cutout portion 208 edges, further shown in FIG. 2B.

FIG. 2B is a cross-sectional view of the handle of the example multi-use hatchet of FIG. 1 taken along line B-B. In some examples, the width of the handle 200 may comprise any appropriate width for a handle 200 of a striking implement, and sized to fit inside a hand of a user. For instance, the width W1 of the handle 200 shown in FIG. 2B may be about ¼ of an inch to 6 inches (e.g., 0.53 inches). In some examples, a cutout edge 210 may generally represent the slope/edge that forms the cutout portion 208 shown in FIG. 2A. In some examples, the cutout edge 210 for the cutout portion 208 in a top (or bottom) part of the hatchet handle may comprise a width W2 of about 1/10 of an inch to 2.5 inches (e.g., 0.13 inches). Further, as shown in FIG. 2B, a hole cutout portion 212 may define the slope/edge that defines the inner circumference of the holes 202, 204, and 206. In some examples, the hole cutout portion 212 for the width of a top/bottom half of a hole 202, 204, and 206 may be a width W3 of about 1/10 of an inch to 2.5 inches (e.g., 0.13 inches). In this way, when the top and bottom portions of the cutout edge 210 and the hole cutout portion 212 are added together (e.g., 0.13 inches), they equate to the entire width of the handle, or about 0.54 inches as described above for W5.

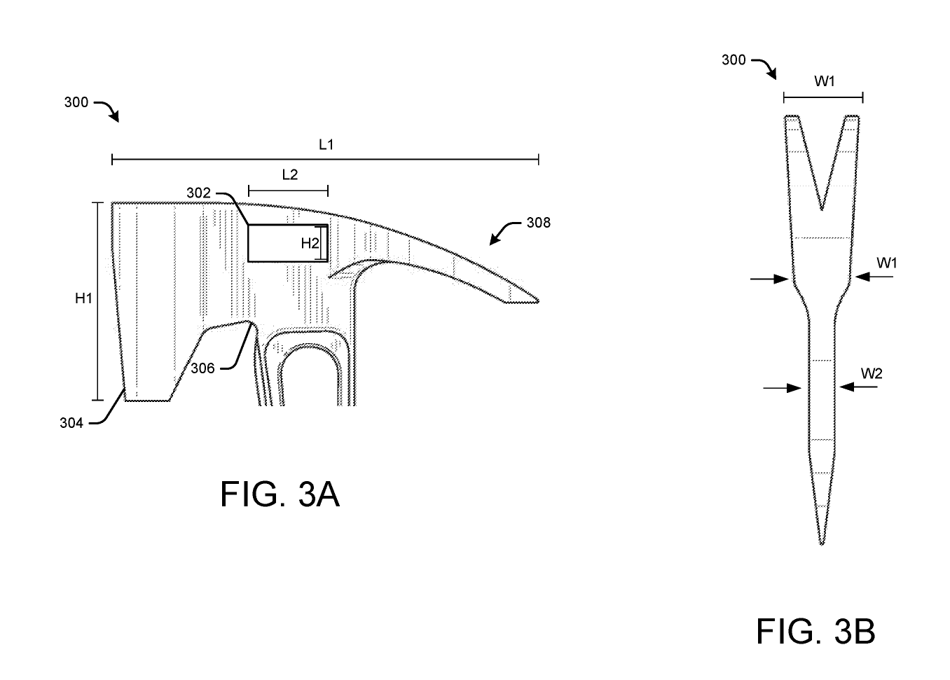

FIG. 3A is a side view of a head of the multi-use hatchet of FIG. 1. In some examples, the head 300 may be the same as head 102 in FIG. 1, and the striking implement may correspond to the hatchet 100 in FIG. 1.

In various examples, the head 300 may comprise various dimensions, such as a length L1 of about 8 inches to 9 inches (e.g., 8.6 inches), and a height H1 of about 4 inches. Similar to the head 102 of hatchet 100, the head 300 may comprise a hole 302 through a width of the head 300. In some examples, the hole 302 may comprise dimensions of a height H2 of about ½ an inch to 1 inch (e.g., 0.63 inches) and a length L2 of about 1 inch to 2 inches (e.g., 1.5 inches). Further, similar to the example hatchet 100 in FIG. 1, the head 300 may include a blade 304, an anchor notch 306, and a plying mechanism 308.

FIG. 3B illustrates a top view of a head 300 of an example multi-use hatchet, such as hatchet 100. As shown in FIG. 3B, the width of the head 300 may change in width. In some examples, the back of the head 300 may comprise a greater width than the front of the head 300. For example, width W1 may be about 1 inch to 2 inches (e.g., 1.1 inches), and width W2 may be about ½ an inch to 1 inch (e.g., 0.54 inches).

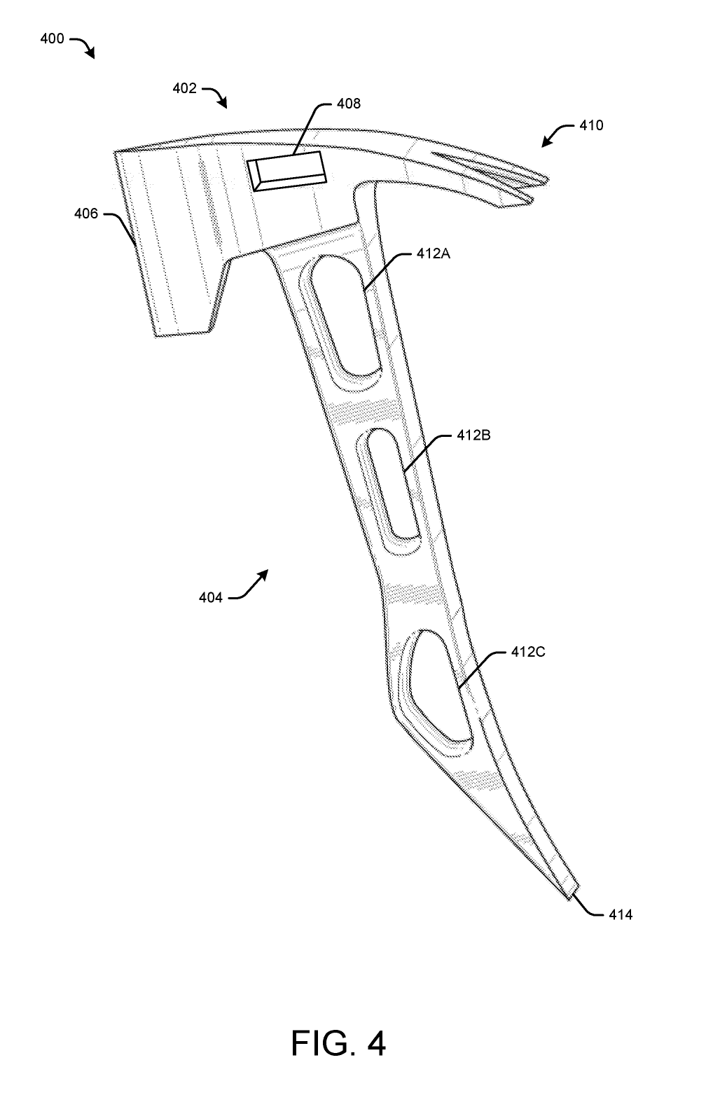

FIG. 4 is a perspective view of another embodiment of an example multi-use hatchet. As shown in FIG. 4, the multi-use hatchet 400 includes a head 402 and a handle 404, similar to head 102 and handle 104. In some examples, the head 402 may have components similar to that of hatchet 100, and may include a blade 406, a hole 408 through the width of the head 402, and a plying mechanism 410.

In various examples, the handle 404 may include one or more holes 412 and a front face and back face which come to a point 414 at the distal end of the handle 404. In some examples, the one or more holes 412 may include a top hole 412A, a middle hole 412B, and a bottom hole 412C. The one or more holes 412 may similarly have interior circumferences comprising substantially rounded edges to prevent friction from rope moving along the edges of the interior of the holes 412.

In contrast to the handle 200 shown in FIG. 2, and similarly in FIG. 1, handle 404 may generally comprise a single width and does not have the cutout portion 208.

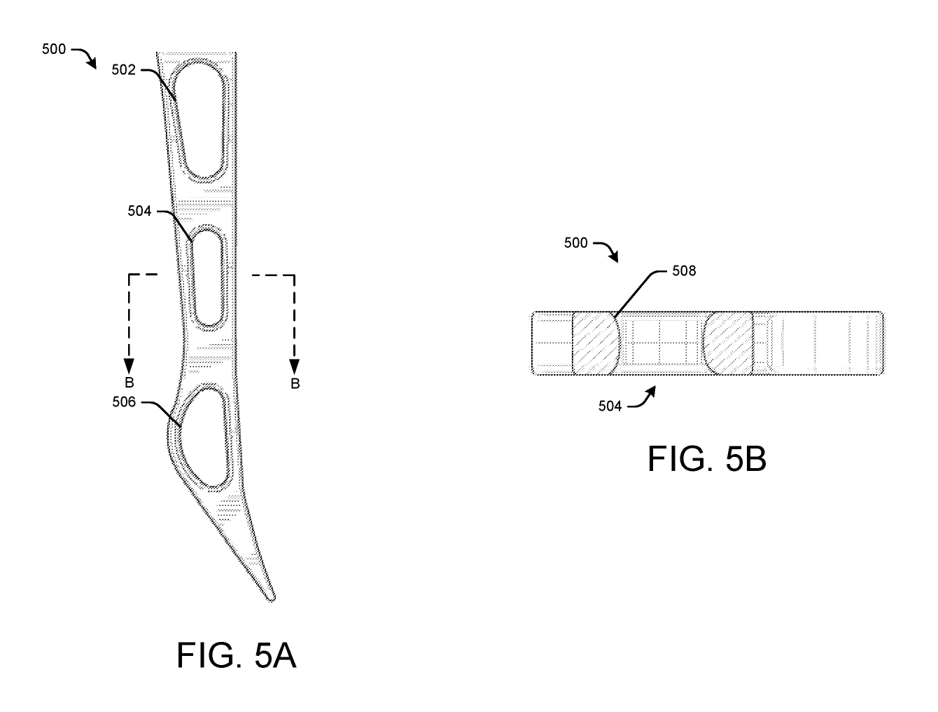

FIG. 5A is a side view of a handle of an example multi-use hatchet, such as the multi-use hatchet of FIG. 4. The handle 500 may include one or more holes, such as top hole 502, middle hole 504, and bottom hole 506. As noted in FIG. 4, the handle 500 may comprise a single width, rather than having cutout edges forming a perimeter around the one or more holes.

FIG. 5B is a cross-sectional view of a handle of an example multi-use hatchet, such as the multi-use hatchet of FIG. 4. FIG. 5B is a cross-sectional view of the handle 500 taken from the perspective illustrated in FIG. 5A. As shown in FIG. 5B, the hole 504 has an interior circumference 508 which is substantially rounded. As opposed to the handle 200 shown in FIGS. 2A and 2B, the cross-sectional view of the handle 500 illustrates the rounded, interior circumference 508 of the hole 504 rather than the hole cutout portion 212. Instead, the handle 500 has substantially a single width through which the holes 502, 504, and 506 extend.

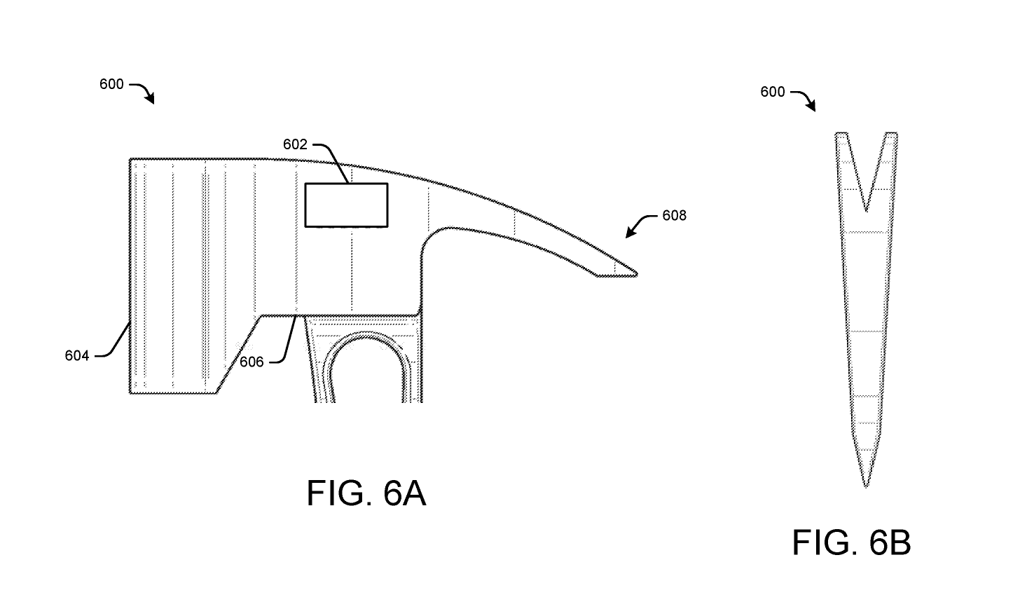

FIG. 6A is a side view of a head 600 of an example multi-use hatchet, such as the multi-use hatchet of FIG. 4. Similar to head 300 in FIG. 3A, the head 600 may comprise a hole 602 through the width of the head, a blade 604, an anchor notch 606, and a plying mechanism 608. In some examples, the anchor notch 606 may not have an indented slot as the anchor notch 306 has in FIG. 3A.

FIG. 6B is a top view of the head 600 of an example multi-use hatchet, such as the multi-use hatchet of FIG. 4. As shown in FIG. 6B, the width of the head 600 of the hatchet decreases in a substantially linear fashion. Conversely, the width of the head 300 shown in FIG. 3B changes at a sharper rate about half way along the length of the head 300.

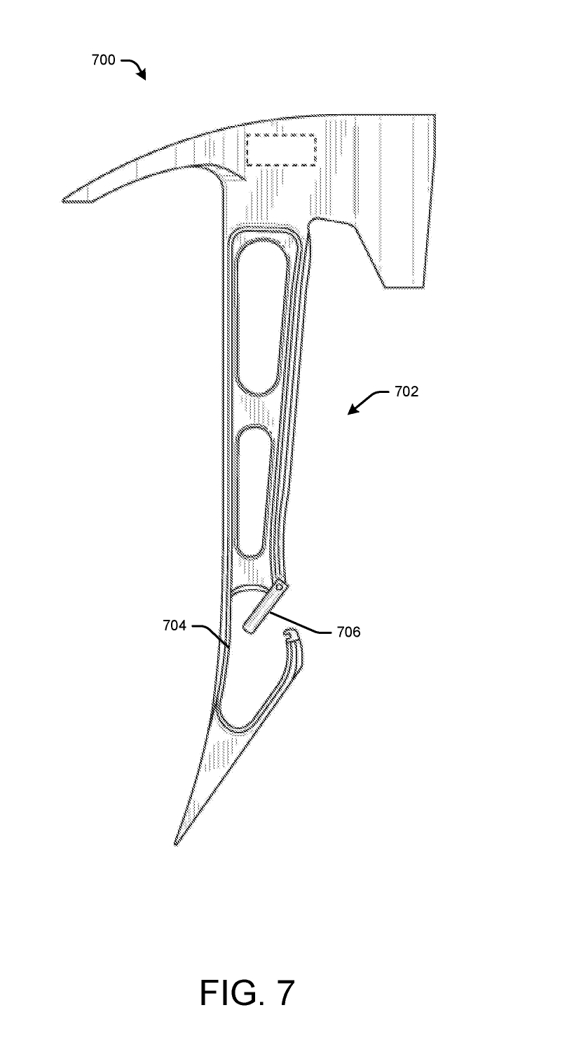

FIG. 7 is a side view of another embodiment of an example multi-use hatchet 700 having a carabiner-type opening mechanism disposed in the handle. As shown in FIG. 7, the hatchet 700 comprises a handle 700, a bottom hole 704, and a latch 706. The latch 706 may be selectively opened or closed to provide a gap in a front face of the handle 702. The latch 706 may function similar to a carabiner latch and provide access for various objects to the hole 704. While the latch 706 is illustrated as the top left portion of hole 704, in other examples, the latch 706 may be on any location of the hole 704, or on any other hole on the handle 700.

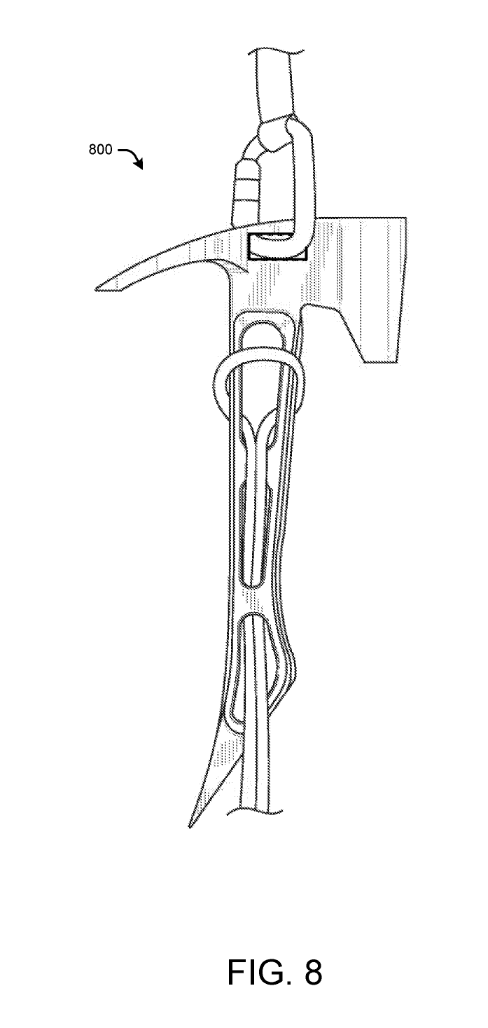

FIG. 8 is an example use case scenario of an example multi-use hatchet. The hatchet 800 of FIG. 8 may be similar to hatchet 100 in FIG. 1. In some examples, the hatchet 800 may include one or more holes sized to receive one or more sections of rope, as illustrated. Further, a hole through the width of the head may be sized to receive an object, such as a carabiner. In some examples, the arrangement and size of the holes in the handle of the hatchet 800 may allow a user to use the hatchet 800 as a belaying and/or repelling device. For example, the carabiner may be hooked to a firefighter using a harness. The handle of the hatchet 800 may then serve as a belaying device by extending from the body of the firefighter, and slowly allowing the rope to move through the holes to safely lower the firefighter, or to alternatively hold the firefighter in place.

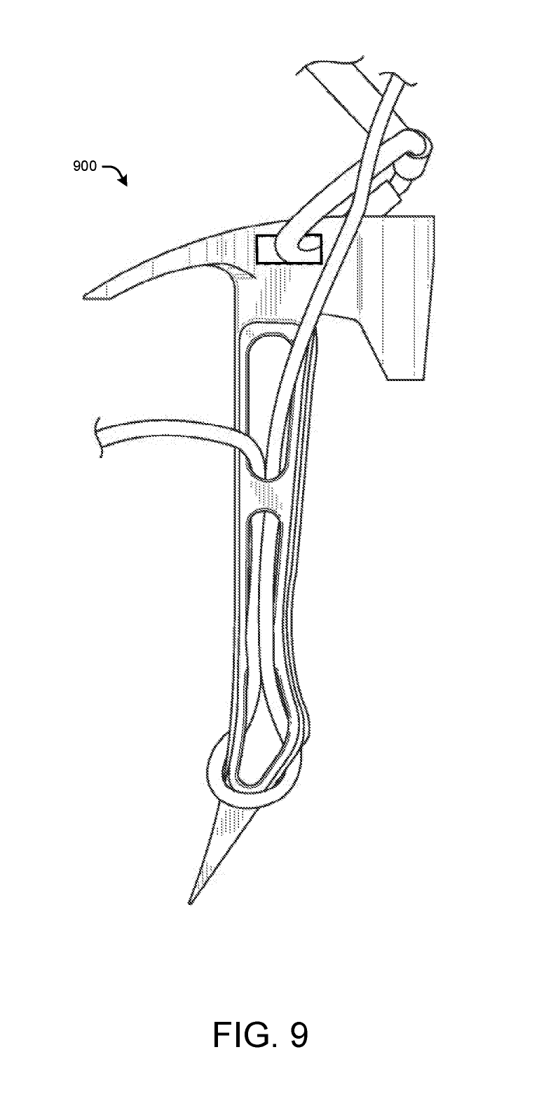

FIG. 9 is another example use scenario of an example multi-use hatchet. In some examples, the hatchet 900 shown in FIG. 9 is similar to the hatchet 100 of FIG. 1. In some examples, the hatchet 900 may also include one or more holes in the handle sized to receive the diameters of two lengths of rope, such as climbing rope. In some examples, each piece of rope may have a diameter of about 0.35 inches to 0.42 inches. Accordingly, each hole in the handle of the hatchet 900 may be sized to receive two lengths of rope with a combine diameter of about 0.70 inches to 0.84 inches. FIG. 9 illustrates another embodiment of how rope may be threaded through the holes in the handle of hatchet 900 to aid in belaying and/or repelling for a user.

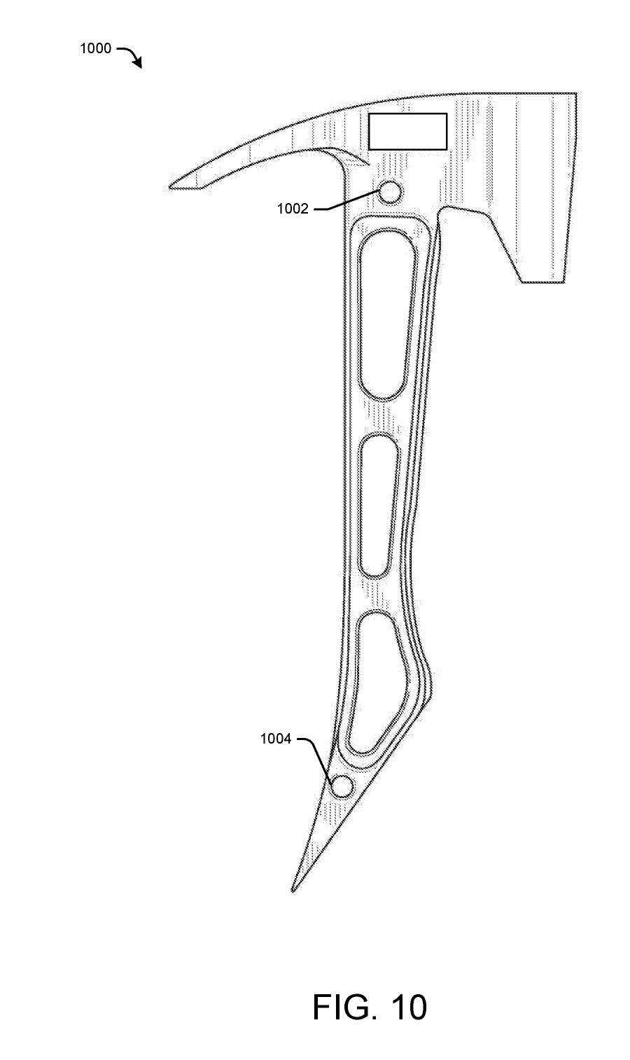

FIG. 10 is a side-view of an example multi-use hatchet 1000. The hatchet 1000 depicted may include one or more boreholes. In some examples, a borehole 1002 may be between the proximal end of the hatchet 1000 handle and a head of the hatchet 1000, and another borehole 1004 may be disposed at a distal end of the handle of the hatchet 1000. In some examples, there may be any number of boreholes (e.g., 1, 2, 3, 4, 5, etc.) and the boreholes may be sized to receive a rope. In some instances, the boreholes 1002 and/or 1004 may serve as locations to loop a rope through for a tie-off location.

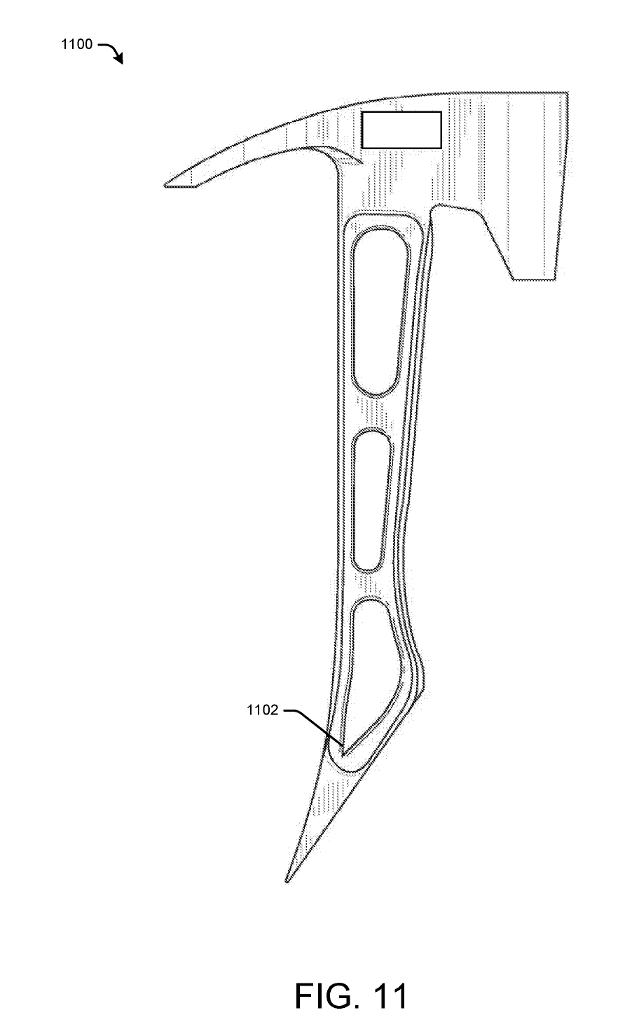

FIG. 11 is a side-view of another example multi-use hatchet 1100. As shown in FIG. 11, a bottom hole on the handle of the hatchet 1100 may comprise a cinch point 1102. While illustrated as being in the bottom portion of the bottom hole, the cinch point 1102 may be in any of the holes on the handle, and at any location in the holes. In some examples, the cinch point 1102 may be sized to lock-in, or cinch a rope to hold the rope in place.

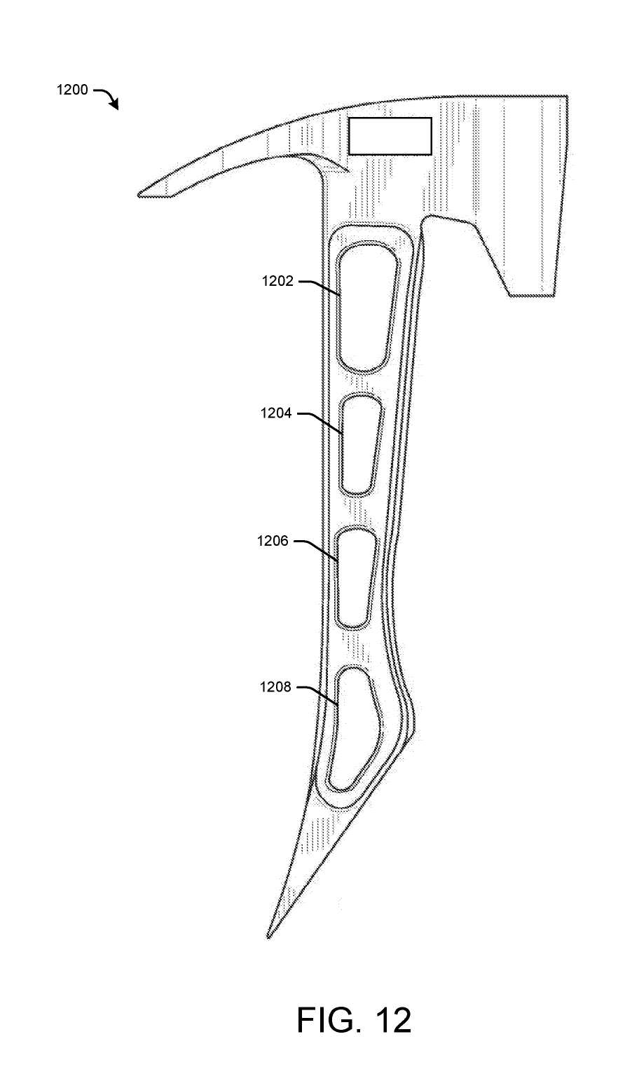

FIG. 12 is a side-view of another example multi-use hatchet 1200. In some examples, the example hatchet 1200 depicted in FIG. 12 may comprise one or more holes (e.g., 1, 2, 3, 4, 5, etc.). As illustrated, the example hatchet 1200 includes 4 holes, or holes 1202, 1204, 1206, and 1208.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A striking implement comprising:
a head; and
a handle having a length extending along a vertical axis with a proximal end coupled to the head and a distal end, the handle comprising:
a first hole disposed in a top third portion of the handle proximate the proximal end;
a second hole disposed in a bottom third portion of the handle proximate the distal end; and
a third hole interposed between the first hole and the second hole, wherein the first hole, the second hole, and the third hole each comprise a smallest dimension of at least 0.35 inches.

2. The striking implement of claim 1, wherein the first hole, the second hole, and the third hole each comprise rounded interior circumferences.

3. The striking implement of claim 1, wherein:
the first hole comprises a first dimension and a second dimension, wherein the first dimension extends along the vertical axis and is greater than the second dimension, the second dimension extending along a horizontal axis;
the second hole comprises a third dimension and a fourth dimension, wherein the third dimension extends along the vertical axis and is greater than the fourth dimension, the fourth dimension extending along the horizontal axis; and
the third hole comprises a fifth dimension and a sixth dimension, wherein the fifth dimension extends along the vertical axis and is greater than the sixth dimension, the sixth dimension extending along the horizontal axis.

4. The striking implement of claim 3, wherein:
the first dimension is greater than the third dimension; and
the third dimension is greater than the fifth dimension.

5. The striking implement of claim 3, wherein:
the first dimension is greater than the third dimension;
the first dimension is greater than the fifth dimension; and
the fifth dimension is greater than the third dimension.

6. The striking implement of claim 1, wherein the head comprises:
a blade;
a hole extending through a width of the head, the width extending along a horizontal axis;
a plying mechanism; and
an anchor notch interposed between the proximal end of the handle and the blade.

7. A striking implement comprising:
a head; and
a handle having length extending along a vertical axis with a first end coupled to the head and a second end, the handle comprising:
one or more holes configured to receive an object having a smallest dimension of at least about 0.3 inches, wherein each of the one or more holes have an interior circumference comprising a rounded edge.

8. The striking implement of claim 7, wherein:
the one or more holes comprise a first hole, a second hole, and a third hole;
the first hole is disposed in a top third of the handle nearest the first end of the handle;
the second hole is disposed in a bottom third of the handle nearest the second end of the handle; and
the third hole is interposed in a middle third of the handle between the first hole and the second hole.

9. The striking implement of claim 8, wherein the handle comprises a front surface and a back surface, and wherein the third hole comprises a portion of the back surface configured to selectively open the portion of the back surface.

10. The striking implement of claim 7, wherein the handle comprises a first width extending along a horizontal axis, the striking implement further comprising:
a first cutout edge defining a perimeter around the one or more holes, the first cutout edge extending from a first surface of a first side of the handle into the handle to define a second width extending along the horizontal axis that is less than the first width; and
a second cutout edge defining the perimeter around the one or more holes, the second cutout edge extending from a second surface of a second side of the handle into the handle to define the second width.

11. The striking implement of claim 10, wherein the first cutout edge and the second cutout edge each comprises a rounded edge.

12. The striking implement of claim 7, wherein the one or more holes each comprise a first dimension extending along the vertical axis of at least about 0.7 inches and a second dimension extending along a horizontal axis of at least about 2.9 inches.

13. The striking implement of claim 7, wherein the handle has a front surface and a back surface, the front surface and back surface coming to form a point at the second end of the handle.

14. The striking implement of claim 7, wherein the head comprises:
a blade; and
an anchor notch interposed between the blade and the first end of the handle.

15. A striking implement comprising:
a head;
a handle comprising a length extending along a vertical axis, the handle comprising:
a first end coupled to the head;
a second end;
a front surface;
a back surface; and
one or more holes disposed through a first dimension of the handle, the first dimension of the handle extending along a horizontal axis;
a first cutout edge extending from a first surface of a first side of the handle to a second surface of the first side of the handle to define a second dimension of the handle extending along the horizontal axis;
a second cutout edge extending from a first surface of a second side of the handle to a second surface of the second side of the handle,
wherein the first cutout edge and the second cutout edge each define a perimeter around the one or more holes disposed through the first dimension of the handle, and wherein the first cutout edge and the second cutout edge extend from the first width of the handle to a second width of the handle, wherein the first width and the second width extend along a horizontal axis.

16. The striking implement of claim 15, wherein the one or more holes each comprise an interior circumference comprising a rounded edge.

17. The striking implement of claim 15, wherein the one or more holes each comprise dimensions configured to receive an object having a smallest dimension of at least about 0.2 inches.

18. The striking implement of claim 15, wherein one or more holes comprise:
a first hole disposed in a top third of the handle nearest the first end of the handle;
a second hole disposed in a bottom third of the handle nearest the second end of the handle; and
a third hole interposed in a middle third of the handle between the top third of the handle and the bottom third of the handle.

19. The striking implement of claim 15, wherein the head comprises:
a blade; and
an anchor notch interposed between the blade and the first end of the handle.

20. The striking implement of claim 15, wherein the one or more holes comprise a first hole, a second hole, and a third hole, and wherein:
the first hole comprises a first dimension extending along the vertical axis and a second dimension extending along a second horizontal axis, the first dimension being greater than the second dimension;
the second hole comprises a third dimension extending along the vertical axis and a fourth dimension extending along the second horizontal axis, the third dimension being greater than the fourth dimension; and
the third hole comprises a fifth dimension extending along the vertical axis and a sixth dimension extending along the second horizontal axis, the fifth dimension being greater than the sixth dimension.
